(19) United States
(12) Patent Application Publication
(10) Pub. No.: US 2009/0248879 A1
(43) Pub. Date: Oct. 1, 2009

(54) System and method for collecting, cataloging, and sharing product information

(75) Inventors: Thomas Martis, Chandler, AZ (US); Sanjay Kotagiri, Chandler, AZ (US); Durgaprasad R. Dabberu, Phoenix, AZ (US); Yong Li, Overland Park, KS (US)

Correspondence Address: DONALD J LENKSZUS, PO BOX 3064, CAREFREE, AZ, 85377-3064, US

(73) Assignee: BUZZOOP, INC., Chandler, AZ (US)

(21) Appl. No.: 12/080,181

(22) Filed: Mar. 31, 2008

(51) Int. Cl. G06F 15/16

(52) U.S. Cl. 709/227

(57) ABSTRACT

In accordance with the principles of the invention a network based social cataloging service is provided that automatically catalogs product information for products that a user views while “window shopping” on the network for retrieval at a later time. Further in accordance with the principles of the invention, a network-based community is provided where a user's cataloged information saved while window-shopping, is shared with other members of the community.

### FIELD OF THE INVENTION

The invention pertains to a system and method for use in conjunction with the Internet, in general, and to a system and method for collecting and cataloging product and pricing information for a community of Internet users, in particular.

### BACKGROUND

With the increased use of the Internet, many Internet users shop on-line or utilize the Internet to do “window shopping” to determine product and price availability. Often, while surfing the Internet or “web”, a user finds an item that the user might want to purchase. If the user is not ready to buy at that moment or for any number of other reasons the user typically moves away from the web page having the item. At some future time, the user remembers the item, but does not remember at what website or under what category the item was found.

It is desirable to provide a system and method that would scan Internet web pages while a user is window-shopping to see if there is valid product information like prices, item names, descriptions, and so on. It would be further desirable that if valid product information is found that the information be automatically captured, saved and cataloged and that such information be later retrievable.

### SUMMARY

In accordance with the principles of the invention an arrangement and method for capturing, saving and cataloging of online shopping information is provided so a user can later retrieve it and view it again.

In accordance with the principles of the invention a social cataloging service is provided that automatically catalogs product information for products that a user views while “window shopping” on the network for retrieval at a later time. Further in accordance with the principles of the invention, a network based community is provided where a user's cataloged information saved while window-shopping, is shared with other members of the community and price discrimination is identified.

Further in accordance with the principles of the invention an application is provided for use on an Internet device that automatically captures product information for a user when a web site is visited that other members of a predetermined Internet community have already visited and where they have cataloged items. If members of the predetermined community have not visited a web site before, then the application provides a mechanism for manually selecting for capture the relevant information. All captured information that is captured is cataloged for future reference.

The arrangement of the present invention is a helper that allows users to keep track of product information that they have viewed on-line and transaction information for items that they have purchased on-line. The arrangement provides product information to users and purchase transaction information of other users to assist a user in making informed purchase decisions. Users benefit from having access to local information as well as having access to information from the network in a safe and secure environment. A user is freed from the challenge of remembering product information identified in “window shopping” on the Internet. A user can become aware of price discrimination that he/she would otherwise not realize.

In accordance with the principles of the invention a method to provide product information to a user of an Internet device, comprises the steps of: establishing a predetermined Internet community comprising the user and a plurality of other users; providing one or more servers for the predetermined Internet community, the one or more servers being accessible by the user via the Internet device and by the other users via other Internet devices; capturing predetermined product information for items from web locations accessed by the user's Internet device and the other users' other Internet devices; operating the one or more servers to automatically catalog the captured predetermined product information to provide cataloged predetermined product information; storing the cataloged predetermined product information in a database; and automatically selectively providing the cataloged predetermined product information to the user when the user visits a web location where one or more of the other users have had predetermined product information captured.

In the illustrative embodiment of the invention, the method includes automatically uploading the captured predetermined product information from the Internet device and the other Internet devices to the one or more servers.

Still further in accordance with the embodiment of the invention the method comprises: installing an application on the Internet device and the other Internet devices; and utilizing the application to capture the predetermined product information and to upload the captured predetermined product information to the one or more servers.

Yet further in accordance with the embodiment of the invention the application is provided as a downloadable application at the one or more servers for downloading to the Internet device and the other Internet devices.

In the method of the embodiment, a user interface is provided as part of the application. The user interface provides a user the option of capturing the predetermined product information automatically; and automatically capturing the predetermined product information at the Internet device via the application if the automatic capture option is selected. The user interface may be used to provide prompts to the user to capture the predetermined product information at the Internet device.

A system is provided in accordance with the principles of the invention to provide product information via the Internet to users of Internet devices. The system comprises one or more servers accessible via the Internet. The one or more servers are accessible by users via the Internet devices. An application is operable on each Internet device to capture predetermined product information for items from web locations that are accessed by users of the Internet devices. The application is operable on each Internet device to upload the captured predetermined product information to the one or more servers. A database is coupleable to the one or more servers. The one or more servers are further operated to receive uploaded captured predetermined product information and to automatically save and catalog the captured predetermined product information in the database to provide cataloged predetermined product information. Each application and the one or more servers cooperatively operate to selectively access cataloged predetermined product information from the database and to selectively download to an Internet devices when that Internet device accesses corresponding product information from a web location.

Further in accordance with the invention, the system automatically uploads captured predetermined product information from the Internet devices to the one or more servers.

In the illustrative embodiment of the invention the application is downloaded from the one or more servers to the Internet devices via the Internet. The application comprises a user interface. The user interface may be utilized to select a community of users such that said one or more servers selectively accesses the cataloged predetermined information uploaded from the community of users for selective downloading to the Internet devices of the community.

In the illustrative embodiment the user interface provides a user the option of capturing predetermined product information automatically. The application captures the predetermined product information at the Internet device if the option is selected.

In the illustrative embodiment, the user interface provides a user of an Internet device prompts to capture the predetermined product information.

Still further in the illustrative embodiment, the user interface is operable to provide a user of an Internet device search functionality of the cataloged predetermined product information.

### BRIEF DESCRIPTION OF THE DRAWING

The invention will be better understood from a reading of the following detailed description of an illustrative embodiment of the invention in conjunction with the drawing figures, in which:

FIG. 1 illustrates a system in accordance with the principles of the present invention;

FIG. 2 is a flow chart; and

FIGS. 3 through 10 are screen shots of a user interface with FIGS. 3A and 3B being expanded portions of portions of the screen shots.

### DETAILED DESCRIPTION

As used herein, the term “Internet” refers to the world wide web of computers as constituted today or in the future. The term is also intended to include other worldwide networks.

The term “Internet device” is intended to refer to computers as well as any other device that can access the Internet, including wireless devices, e.g., Blackberries, cellular telephones, mobile devices, and the like.

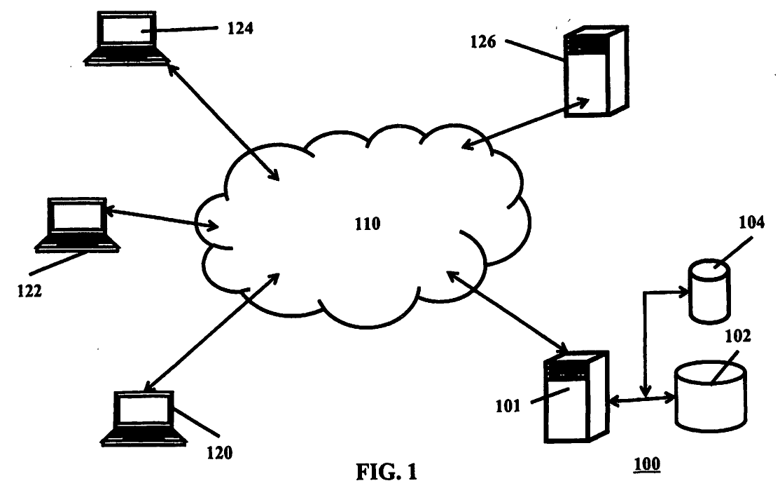

Turning now to FIG. 1, the system 100 of the invention includes a server 101 and database 102 coupled to a public accessible worldwide network such as the Internet 110. Users of system 100 may log onto system 100 from Internet accessible devices such as computers 120, 122, 124 or from any other Internet device. It should be noted that the invention is not limited to the use of computers as devices for accessing the system, but may include any type of device that has network access ability, including, but not limited to, telephones, cellular phones, personal digital assistant (PDA) devices, computers, and specialized devices.

Server 101, when accessed by a user Internet device 120, 122, 124 can download an application 104 that provides user interface capabilities and captures product information when the user is viewing product information from a web site that is hosted on another server 126. Although only one web site server 126 is shown, it will be understood that any number of web site servers and web sites may be accessed via the Internet 110. When the application 104 is installed on Internet device 120, 122, 124, the application works in conjunction with server 101 to capture predetermined product information and upload the predetermined product information to server 101 for saving and cataloging in database 102.

The Buzzoop™ application is downloadable to any Internet device from the Buzzoop™ Web site server. After the application is downloaded, it is installed and the user registers as part of the Buzzoop™ community. Once the Buzzoop™ application is downloaded to an Internet device and installed, a distinctive icon is provided and displayed on the Internet device screen. A user activates the Buzzoop™ application by double-clicking on the icon. Alternatively the application may be activated by use of the Start menu or any of the other methods utilized on Internet devices to activate an application.

As a user “surfs” the Internet, the Buzzoop™ application automatically scans the web pages to see if there is valid product information like prices, item names, descriptions, and so on. If Buzzoop™ finds valid information, then it first tries to automatically capture the information and if it cannot, it presents an Alert message asking the user if the user wants to capture information from the current page and provides a “capture” button for clicking on to capture and catalog the item.

The illustrative embodiment of the invention provides an Internet server 101 and a downloadable application 104 referred to as Buzzoop™. The Buzzoop™ application 104, when downloaded to an Internet device 120, 122, 124, scans web pages, for example pages from server 126, while the user is window-shopping to determine if the web pages contains valid product related information, including information such as prices, item names, descriptions, and the like. If the Buzzoop™ application 104 identifies valid product information, then the application 104 first tries to automatically capture the information. If the application cannot capture the information, it presents a predetermined message, referred to as an “Alert” message, asking the user if the user wishes to capture information from the current page. If the user confirms that the information is to be captured, the application presents a “capture ” button, which, if “clicked” on, presents a browser toolbar with which the user can manually capture and catalog information from a web page.

The present invention provides perfect transparency to pertinent product information that has been viewed and transaction information of products that have been purchased on a user's computer such that this information is searchable, initially by the user, and over time, by participants of a “community” created by users that all have the Buzzoop application.

The “community” in this context is defined as the group of users that have downloaded the Buzzoop application and have agreed to share ‘select’ information mined from each “product page” that has been viewed and/or purchase transactions that have been executed on each user's Internet device.

Each user benefits from access to and search of a history of all the product information that the user has viewed in the past and transactions that the user has executed in the past, including product reviews, comments and coupons posted; and from access to the information for products that other individuals have viewed and/or purchased which enables the individual conducting the search for said information to make informed purchase decisions.

Vendors benefit from the arrangement of the invention since it provides for better usage of coupons and promotion codes; exposure to a larger group of new customers; and the resulting increased revenue as a result of the new customers

The Buzzoop™ website hosted by server 101 accessible via the Internet 110 has the Buzzoop™ application 104 for download. Application 104 is the mechanism by which users get access to the capture and catalog capabilities of the arrangement.

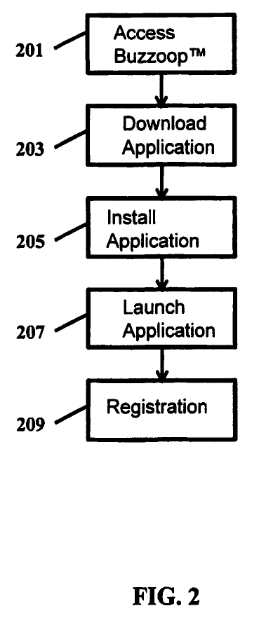

Turning now to FIG. 2, a user at an Internet device 120 first accesses at step 201 the Buzzoop™ website server 101. To provide the Buzzoop™ application 104 on an Internet device 120, a user can download the Buzzoop™ application 104 from the website. Assuming the user elects to download the application, server 101 downloads the application to the user's Internet device 120 at step 203.

An end-user license agreement is presented to the user and assuming the user accepts the terms of the agreement, the user can click on an “install” button and the application is automatically installed. Installation of the downloaded Buzzoop™ application 104 at step 205 is in a standard Wizard setup format. After installation the user may launch application 104 at step 207.

After application 104 has been installed, the user is asked to register at step 209 by providing the following information: Username; Password; full name; Email address; and other predetermined information.

If application 104 is launched, a Buzzoop™ icon appears in the taskbar. Application 104 can be opened by clicking on the icon or by any of the other conventional ways of opening an application.

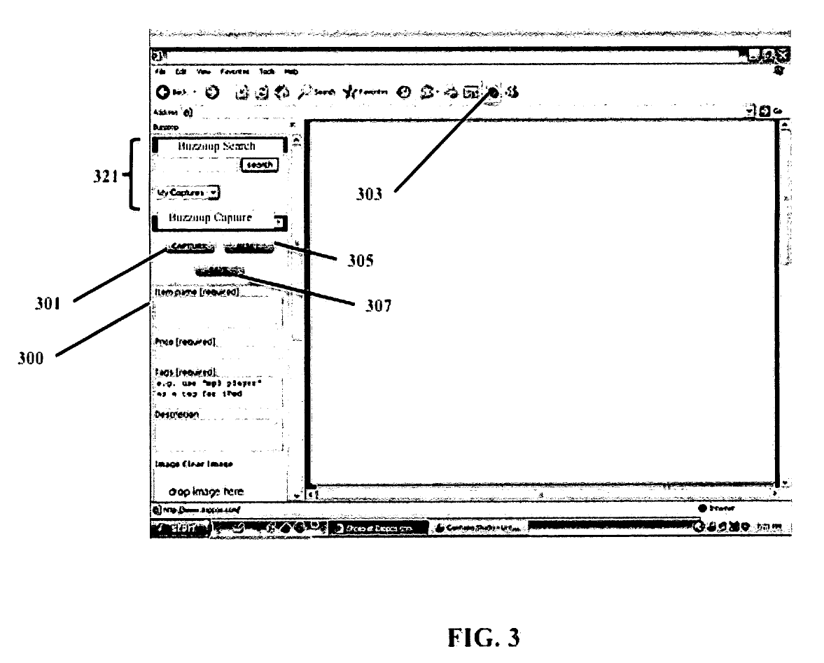

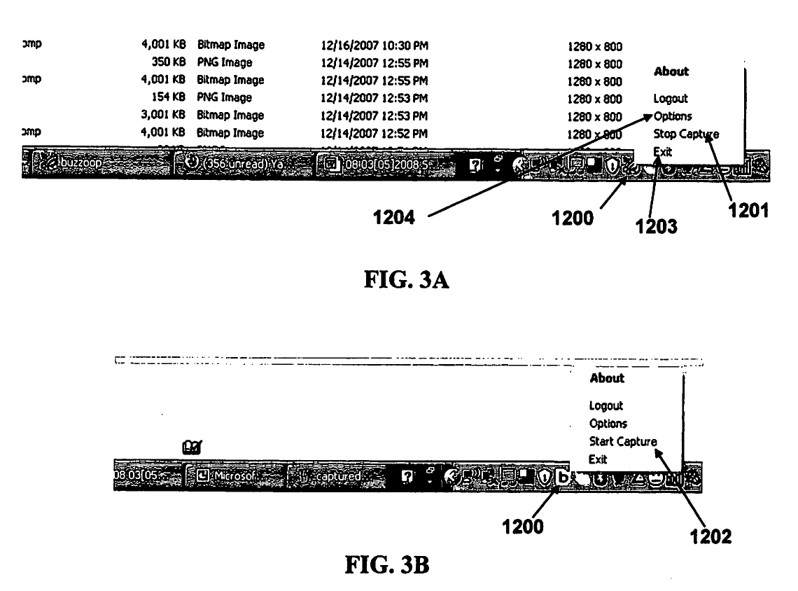

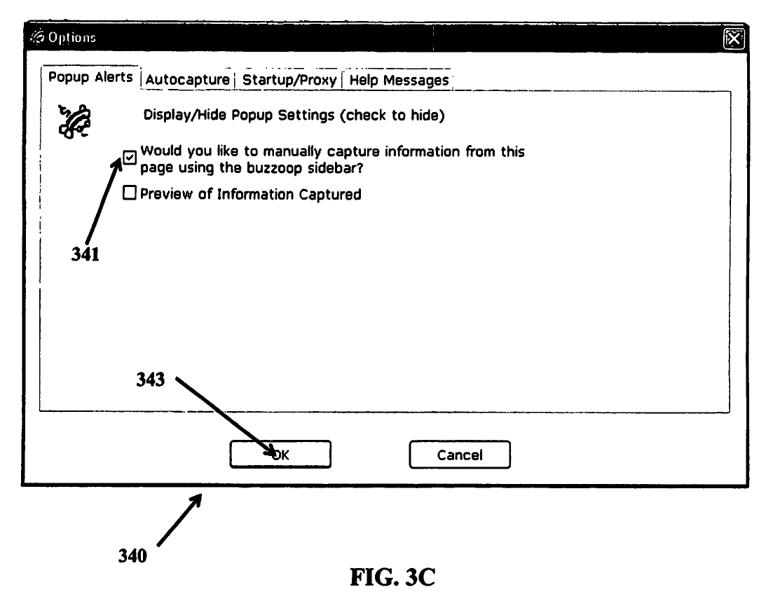

Application 104 provides a user interface 300 shown in FIG. 3. User interface 300 is how and where a user gets access to most of the visible capabilities of the Buzzoop™ system. This is also where the user can modify settings for use of the system. User interface 300 resides in the desktop tray when closed and the user has the ability to close application 104 from the tray. All of user interface 300 is deliverable as part of application 104 from the Buzzoop™ server 101 via the Internet 110. This ensures that updates to user interface are seamless and easily manageable.

User interface 300 includes browser sidebar 319. Browser sidebar 319 is provided for transaction capture and as a template creation aid. The two capabilities are intertwined.

User interface 300 includes a tray icon 1200 shown in FIGS. 3A and 3B. Clicking on tray icon 1200 opens an “about” pop-up menu that allows the user to turn off and turn on the page capture feature by clicking on stop capture selection 1201 and to start capture by clicking on the start capture selection 1202. When a user selects stop capture, the Buzzoop™ application 104 is still running but the user cannot perform any page captures until re-enabling the page capture capability by clicking on start capture selection 1202.

Tray icon 1200 includes an “exit” function, enabled by clicking on exit selection 1203 that allows the user to exit application 104. When application 104 is exited, it is no longer running at all and no page captures occur until restarted.

A transaction, as used herein, is defined as the detection of a web page where there is product information along with price information. There are two types of transactions that can potentially be captured, one is a “Product Page,” i.e., a non-encrypted http page, while the other is a “Transaction page,” i.e., an encrypted https page. A transaction can be of any item on the Internet. The capture capability is as frictionless as possible. The definition of “frictionless” is where ‘minimal’ to ‘no’ interaction is necessary for all pertinent details of the transaction to be captured.

The mechanism employed by system 100 is heuristics and templates. The heuristics are flexible and capable enough to take over most of the tasks associated with the capture of transactions and pertinent information in the transactions with the remaining burden of identifying the remaining pertinent information falling on the first member user to visit the ecommerce site. The information that a user identifies is saved as a template whereby this information is shared with other users of this application.

System 100 captures information from websites such as a website hosted at server 126 of FIG. 1 via applications 104 that are utilized at user Internet devices, 120, 122, 124. One goal is to get the user the best available price. Application 104 provides a capability whereby it deletes website cookies after a user has visited a website and captured information and also deletes any tracking cookies placed on the user's Internet device.

For manual capture capability, a user clicks on options 1204 as shown in FIG. 3A. Clicking on options 1204 opens the options window 340 shown in FIG. 3C. By checking the manual capture option 341 and clicking on the ok button 343, three buttons and several fields are provided in sidebar 319. The buttons include capture 301, reset 305 and save 307 buttons shown in FIG. 3.

Capture button 301 is clicked when the user wants to capture information from the current page. Clicking on the capture button does the following:
Disables the capture button 301;
Enables the reset button 305 and save button 307;
Highlights content on the webpage that is available for capturing; and
Disables the ability to browse.

Reset button 305 is clicked when the user wants to return to browsing. Clicking on the reset button does the following:
Enables the capture button 301;
Disables the reset button 305 and save buttons 307;
Removes the highlights from the content on the current webpage; and
Returns the browser to normal browsing mode.

Save button 307 is clicked to upload and catalog the content placed into the available fields, i.e., item, description, price, and other fields, to the Buzzoop™ server and makes the content available to the entire Buzzoop™ community of users for viewing when those users conduct searches using Buzzoop™ search. Clicking on the save button 307 does the following:
Enables the capture button 301;
Disables the reset button 305 and save button 307; and
Saves the content placed into the fields.

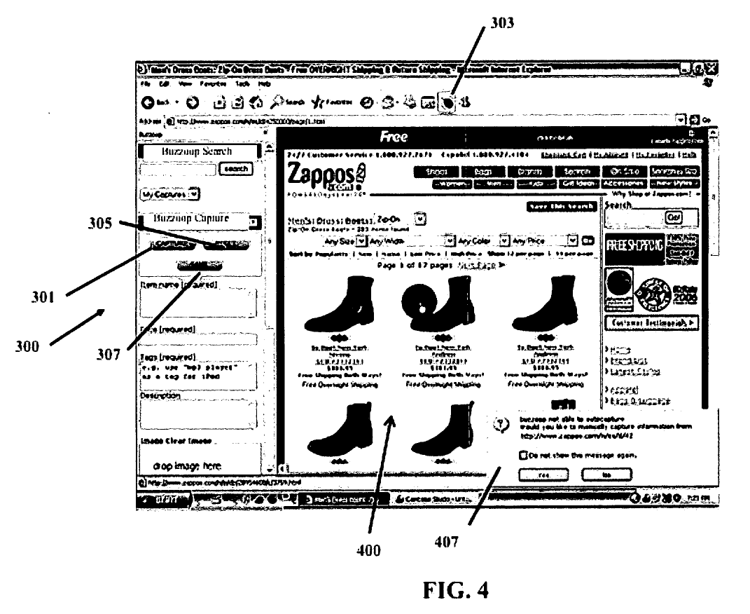

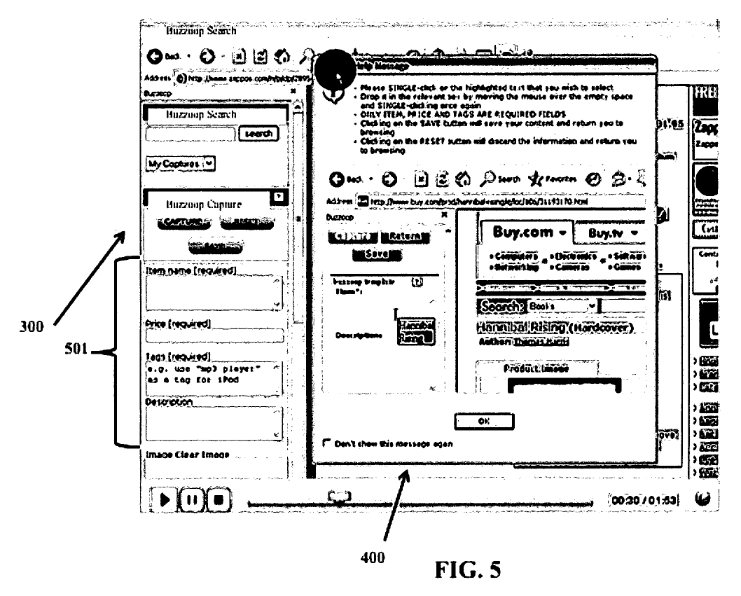

When a webpage 400 has been previously accessed by a user in the Buzzoop™ community, product information is captured automatically. If the webpage 400 has not been previously accessed, an alert message 407 pops up as shown in FIG. 4.

Clicking on yes button 411 in alert 407 brings up sidebar 319 in FIG. 3 that allows the user to manually capture information from web page 400. In the event that an alert does not popup permitting the user to capture information from the current webpage, the user may access the capture function by clicking on the Buzzoop™ icon 303 in the browser toolbar.

After the capture function is enabled, a capture template 501 is provided and the user can place content into the available fields.

All fields in template 501 can be edited. Only the item, description, and price fields are required and have to be filled in, either with text that the user has selected from the web page by dragging and dropping or text that the user has typed into the field.

After content from web page 400 is cataloged, the next visit to the same web site will result in Buzzoop™ system 100 attempting to automatically capture information from the new page being visited using the template you created. If Buzzoop™ system 100 is able to automatically capture this new information via application 104, an alert message will display the content that was captured.

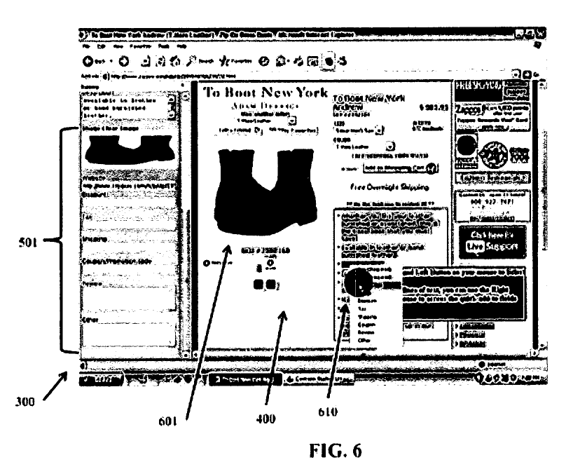

Application 104 also enables capture of product images 601 as part of the capture process and provides optional fields in template 501 where users can enter additional information such as categorical information, e.g., amplifier, may be categorized under both “amplifiers” and “electronics,” and general descriptive information including reviews. As shown in FIG. 6, a picture of the item 601 is added to the template by dragging and dropping.

Buzzoop™ system 100 relies on users to fill in the gaps with respect to information that exists on any given page that the application is currently capturing. A capability is provided that makes this job extremely easy. A user template creation aid or mapper 610 as shown in FIG. 6 highlights areas of a webpage 400 that a user can then select and drop in the fields provided in sidebar 319.

While the creation aid 610 “pops” up anytime the Buzzoop™ application 104 detects that there is useful product information or purchase transaction information on a given page, the creation aid 610 can also be “forced” to appear by the user if it is not triggered automatically.

When saving data using an existing template, a user is shown the content that has been captured with an option to re-capture. The user has the option to re-capture the content that has been captured and also, to add a category or tag. There is a check box that will prevent an alert from being displayed in the future. Once disabled, these checkboxes can be re-enabled by checking the appropriate check box in the Options interface menu 340 shown in FIG. 3C by clicking the options selection button 1204 shown in FIG. 3A.

Buzzoop™ system 100 records the number of unique templates created by users. If new templates are created or if existing templates are modified, the information is transmitted to the Buzzoop™ server 101.

Buzzoop™ system 100 provides recognition to members in the community for templates that they create and share with the community. The recognition is the prominent placement of the users that have created the most templates in the user interface.

A user may search for items from the user's own transaction history and from the transaction histories of other Users. The user is able to view all of his/her local product captures or all of his/her transaction captures or all of both product captures and transaction captures. The user is provided a basic string search that is accessed by the button in field 321 shown in FIG. 3.

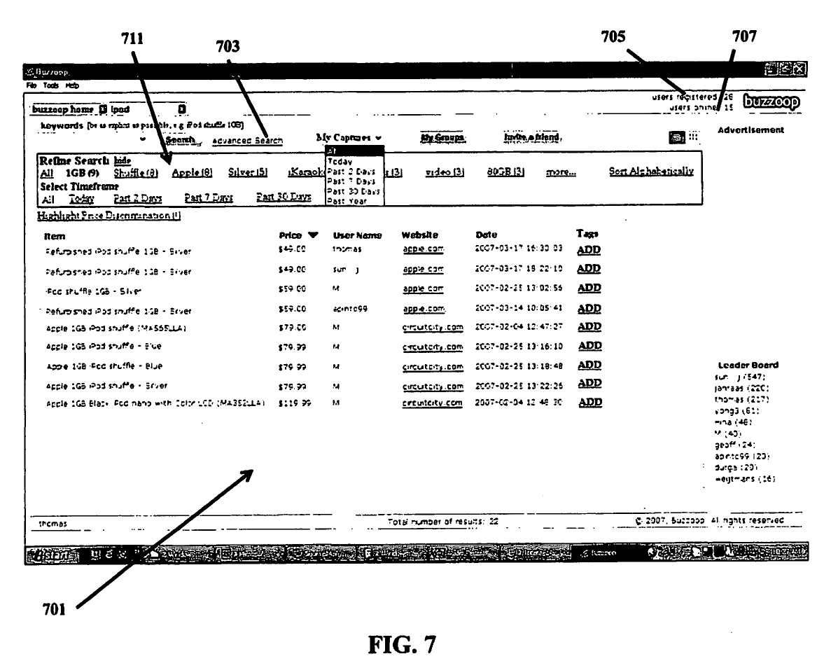

A user may search for saved/catalogued information. A search window 701 as shown in FIG. 7 may be brought up in one of any well-known methods for accessing a function. One method supported by the present application is by launching a search by first accessing a search window. Searches may be for any term (e.g., Motorola) or a collection of terms (e.g., hydration drink). A search field maintains a history of prior search terms used and auto-completes, if possible. The terms can be cleared by selecting clear search history.

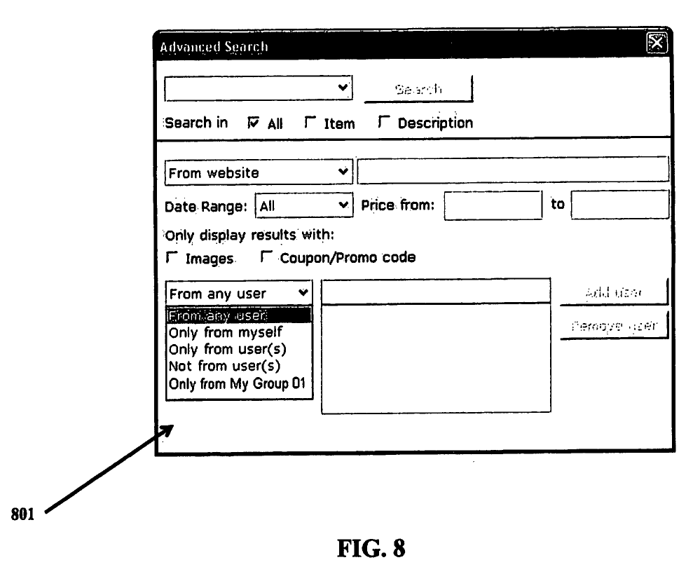

The user may further refine the search by clicking on an advanced search link 703 that brings up an advanced search window 801 as shown in FIG. 8.

A number of fields are provided that inform the user of useful information. One set of fields 705, 707 show the total number of registered users in the Buzzoop™ community and the number of Buzzoop™ users currently online as shown in FIG. 7. Another field shows the usemame of the person currently logged into Buzzoop™.

Another field shows the number of results found for the current search, and a progress bar for the current search is shown.

A further field shows a list of users who have contributed the most content to the Buzzoop™ community.

A “my captures” field allows a user to quickly view the information that the user has either auto-captured or manually captured over a selected time-period of either “all”, “today”, “past 2 days”, “past 7 days”, “past 30 days,” or “past year”.

“My groups” allows the user to create groups of users. When performing an advanced search, the user can use a group that the user created as one of the switches to narrow the user's search. By way of example, the user may use advanced search to find all content that the user's selected group has catalogued over the past 7 days.

A user can refine the search based on the combination of parameters set in the fields. The advanced search fields shown in FIG. 8 have all the capabilities of the general search plus the capability to enter an asterisk (*) in the “any of these words” field as a wildcard term for ALL (i.e., it need not be appended to a two-character term).

A user can limit a search to the check-marked input fields.

A user can include or exclude a specific website in the search by selecting “from website/domain” or “exclude website/domain,” respectively and then inputting the website/domain of interest in the associated field.

A user can limit a search to information catalogued in a specific timeframe; choices include Today, Past 2 Days, Past 7 Days, Past 30 Days or Past Year.

A user can limit a search based on price: two (2) fields are provided for lower and upper bounds.

A user can limit a search to show only those results that have Images and/or a Coupon/Promo Code associated with them.

A user can limit a search based on who catalogued the content. A user can include content catalogued by the user only, or content catalogued by one or more other users, or content that is not from specific users, or content from groups that the user have created.

Each search result is displayed in a separate tab that can be closed by clicking on a designated portion of each tab. When there are too many tabs open, the leftmost ones will be hidden and a set of directional arrows will allow the user to navigate to the tab of interest.

Search results can be displayed either in list view or thumbnail view by clicking on the respective button.

Information from each search result is separated into columns representing the item name, price of the item, user name, website where the information was captured from, date that the information was captured and any tags to categorize the information that may have been added. Three dots after the term “add” under the “tags” column indicate that the listing has been tagged.

Results are sorted in ascending price order. Clicking any of the column headers toggles the results between ascending and descending order for that column.

Moving the mouse over any listing will present a popup showing more details on the item.

In the popup that is presented, clicking on the “show all details” button will open a window that shows all the information that has been catalogued for a given item.

Search results can be further refined using the refine search capability either by selecting individual terms that exist within the listings or by timeframe.

A listing can be deleted or edited by the person who originally catalogued the information.

An incremental capability is provided where the results of a “Froogle” search or other price search engine are displayed such that the user can do an actual comparison of the Buzzoop™ results versus the other price search engine results. This is provided as a browser window within our application with links for all major price search engines.

When Buzzoop™ system 1 detects a transaction and detects the item(s) being purchased, it performs a search automatically and finds and displays all items purchased by other members on the network that match the item currently being purchased.

Users that conduct searches can tag individual results as “garbage”; i.e. the information that was captured is garbage. When a predetermined number, e.g., 10, of unique users mark the same result as “garbage,” the result gets purged from database 102.

Users that conduct searches will be allowed to tag individual search results with categories the result wasn't originally tagged with. For example, if information was captured for a Treo 600 Headphone accessory, and another user executes a Search for Treo 600, this accessory will be returned as a result because the original user did not tag it as an accessory. In this case, the second user that conducted the search can tag this item as an accessory which will update the result with this tag in database 102.

Search results are presented with at least the following information segmented out: search date, searched item, item description, and a link for the page where the information was gathered. The link can be clicked to go to that page whereby the system will capture the information again, thus maintaining the latest price for that product at that site.

A user has access to his/her search history which will show the search strings. The results for search strings are available for the duration that the Buzzoop™ application is open. Closing the application removes the results. The number of search strings will default to a predetermined number, e.g., 25. The user has the ability to increase or decrease this number or to never save search histories. In the ‘never’ case, the old search history will be deleted every time a new search string is entered, i.e., only current results are shown.

Buzzoop™ system 100 captures and presents pertinent statistics, including: total number of registered users; total number of users currently online; total number of searches executed by members; and the top ten individuals with the most number of unique templates created and information cataloged.

Buzzoop™ system 100 allows users to communicate with other users as long as they know the user's name. Users can search for other users using string searches, however, these searches are confined to searching of personal information only that a user has wished to expose. Usernames cannot be searched.

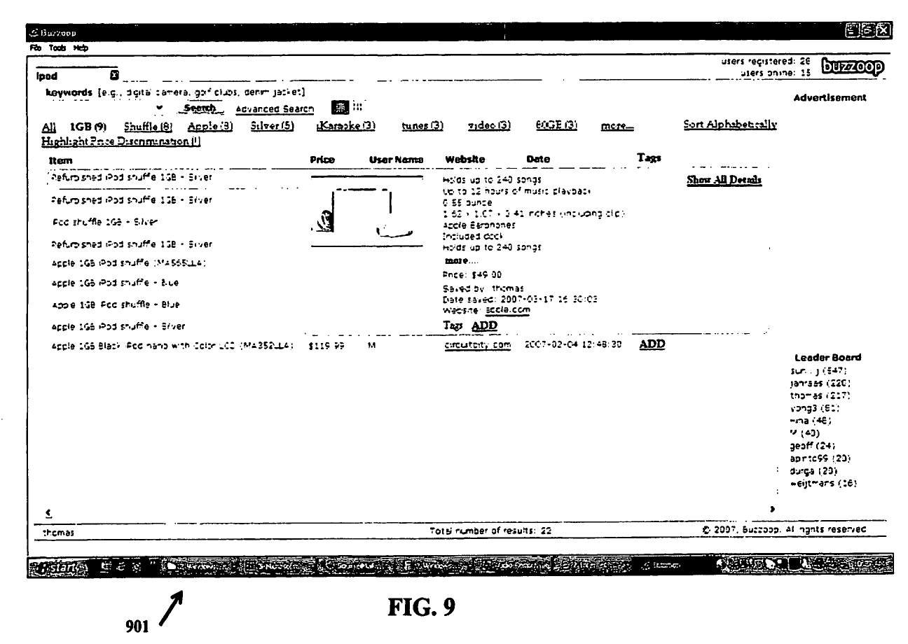

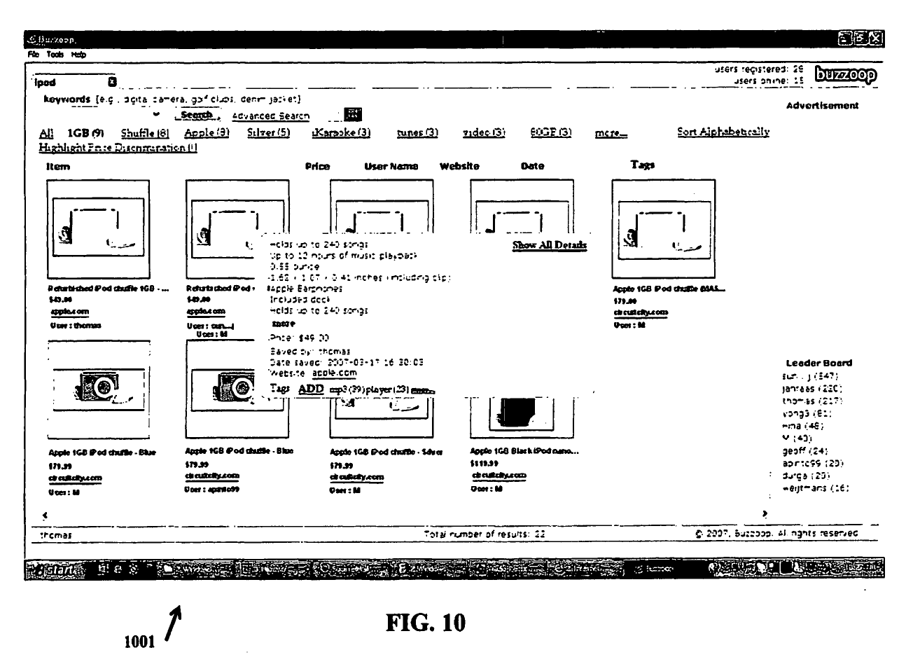

FIGS. 8, 9, and 10 illustrate various user interface views of search results 801, 901, 1001 as described above.

The invention has been described in conjunction with an illustrative embodiment of the invention. Those skilled in the art will appreciate that various changes may be made to the embodiment without departing from the spirit or scope of the invention. It is not intended that the invention be limited in any way to the specific illustrative embodiment shown and described.

What is claimed is:

1. A method to provide product information to a user of an Internet device, comprising:
establishing a predetermined Internet community comprising said user and a plurality of other users;
providing one or more servers for said predetermined Internet community, said one or more servers being accessible by said user via said Internet device and by said other users via other Internet devices;
capturing predetermined product information for items from web locations that said user Internet device and said other users other Internet devices access;
operating said one or more servers to automatically catalog said captured predetermined product information to provide cataloged predetermined product information;
storing said cataloged predetermined product information in a database; and
automatically selectively providing said cataloged predetermined product information to said user when said user visits a web location where one or more of said other users have had predetermined product information captured.

2. A method in accordance with claim 1, comprising:
automatically uploading said captured predetermined product information from said Internet device and said other Internet devices to said one or more servers.

3. A method in accordance with claim 2, comprising:
installing an application on said Internet device and said other Internet devices; and
utilizing said application to capture said predetermined product information and to upload said captured predetermined product information to said one or more servers.

4. A method in accordance with claim 3, comprising:
providing said application as a downloadable application at said one or more servers for downloading to said Internet device and said other Internet devices.

5. A method in accordance with claim 3, comprising:
providing a user interface as part of said application.

6. A method in accordance with claim 5, comprising:
providing a user the option of capturing said predetermined product information automatically; and
automatically capturing said predetermined product information at said Internet device via said application if said option is selected.

7. A method in accordance with claim 5, comprising:
utilizing said user interface to provide prompts to said user to capture said predetermined product information at said Internet device.

8. A method in accordance with claim 5, comprising:
utilizing said user interface to provide search functionality of said cataloged predetermined product information.

9. A system to provide product information via the Internet to users of Internet devices, comprising:
one or more servers accessible via said Internet, said one or more servers being accessible by said users via said Internet devices;
an application operable on each of said Internet devices to capture predetermined product information for items from web locations that each of said users of said Internet devices access, said application operable on each of said Internet devices to upload said captured predetermined product information to said one or more servers;
a database coupleable to said one or more servers;
said one or more servers being further operated to receive said uploaded captured predetermined product information and to automatically save and catalog said captured predetermined product information in said database to provide cataloged predetermined product information; and
each said application and said one or more servers cooperatively operating to selectively access from said database and to selectively download to one of said Internet devices selected said cataloged predetermined product information to said one Internet device when said one Internet device accesses corresponding product information from a web location.

10. A system in accordance with claim 9, comprising:
automatically uploading said captured predetermined product information from said Internet devices to said one or more servers.

11. A system in accordance with claim 9, wherein:
said application is downloaded from said one or more servers to said Internet devices via said Internet.

12. A system in accordance with claim 9, wherein:
said application comprises a user interface.

13. A system in accordance with claim 12, wherein:
said user interface may be utilized to select a community of users of said Internet devices such that said one or more servers selectively accesses said cataloged predetermined information uploaded from said community of users for selective downloading to said Internet devices in said community.

14. A system in accordance with claim 12, wherein:
said user interface provides a user the option of capturing said predetermined product information automatically; and
application captures said predetermined product information at said Internet device via said application if said option is selected.

15. A system in accordance with claim 12, wherein:
said user interface provides a user of an Internet device prompts to capture said predetermined product information at said Internet device.

16. A system in accordance with claim 12, wherein:
said user interface is operable to provide a user of an Internet device search functionality of said cataloged predetermined product information.

17. A method to provide product information to a user of an Internet device, comprising:
establishing a predetermined Internet community comprising said user and a plurality of other users;
providing one or more servers for said predetermined Internet community, said one or more servers being accessible by said user via said Internet device and by said other users via other Internet devices;
capturing predetermined product information for items from web locations that said user Internet device and said other users other Internet devices access;
operating said one or more servers to automatically catalog said captured predetermined product information to provide cataloged predetermined product information;
storing said cataloged predetermined product information in a database; and
automatically selectively providing said cataloged predetermined product information to said user when said user visits a web location where one or more of said other users have had predetermined product information captured; and
identifying instances of price discrimination.
